(19) United States
(12) Patent Application Publication
(10) Pub. No.: US 2017/0306204 A1
(43) Pub. Date: Oct. 26, 2017

(54) METHOD OF MANUFACTURE OF LEAK STOPPING FORMULATION

(71) Applicant: Matthew Kevin FERRIS, Riverstone NSW (AU)

(72) Inventor: Matthew Kevin FERRIS, Riverstone NSW (AU)

(21) Appl. No.: 15/644,868

(22) Filed: Jul. 10, 2017

Related U.S. Application Data
(63) Continuation of application No. 14/451,933, filed on Aug. 5, 2014, now abandoned.

(51) Int. Cl. C09K 3/12; F01P 3/20

(52) U.S. Cl. CPC C09K 3/12; F01P 3/20

(57) ABSTRACT

A method of use of waste sawdust derived from engineered wood; the method including the steps of:
collecting the waste sawdust from an engineered wood product manufacturing facility,
passing the waste sawdust through at least one sieving operation,
in a mixer, combining the waste sawdust with selected ingredients to form a cooling system leak stopping product.

### TECHNICAL FIELD

The present invention relates to products to stop leaks in the cooling systems of motor vehicles and, more particularly, to a method of manufacturing of such a product.

### BACKGROUND

Leaks in the cooling liquid circuit of an internal combustion engine, if left unattended, can cause serious damage to the engine. Leaks may develop in a variety of parts of the system, including the radiator, cylinder head gasket, welsh plugs and even through micro cracks in the cylinder block or cylinder head.

Numerous products are available on the market for at least temporary stopping or ameliorating such leaks. The more efficacious of these may contain toxic agents and generally require a time consuming and involved procedure, including complete drainage of the cooling system, a subsequent flushing with a preparatory formulation, the addition of the leak stopping agent and replenishment of the cooling liquid.

Waste sawdust, in particular that deriving from the cutting of engineered wood or Low Density Fibreboard (LDF) is these days produced in large volumes since a very large proportion of domestic and office furnishings now use this form of material. As landfill solutions to the disposal of waste products become more expensive, the disposal of the LDP sawdust becomes an ever greater impost on industry.

It is an object of the present invention to address or at least ameliorate some of the above disadvantages or provide a useful alternative.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly, in one broad form of the invention there is provided a method of use of waste sawdust derived from engineered wood; the method including the steps of:
collecting the waste sawdust from an engineered wood product manufacturing facility,
passing the waste sawdust through at least one sieving operation,
in a mixer, combining the waste sawdust with selected ingredients to form a cooling system leak stopping product.

Preferably, particles of the waste sawdust are at least partially coated by an adhering adhesive resin.

Preferably, the selected ingredients include a proportion of powdered copper.

Preferably, the selected ingredients include a proportion of lead monoxide.

Preferably, the proportion of particles of waste saw dust comprises between 71% and 83% of the product by volume.

Preferably, the proportion of powdered copper comprises between 15% and 25% of the product by volume.

Preferably, the proportion of lead monoxide comprises between 2% and 6% of the product by volume.

Preferably, the product is added to the cooling liquid in a perforated cooling system.

Preferably, the product is transported to a perforation site in a cooling system by circulating cooling liquid in the cooling system.

In yet a further broad form of the invention, there is provided a method of manufacturing a product; the product including a proportion of waste sawdust derived from engineered wood; the method including the steps of:
collecting the waste sawdust from an engineered wood product manufacturing facility,
sieving said waste sawdust to remove impurities,
adding a predetermined quantity of the waste sawdust to a drum mixer,
adding further predetermined quantities of powdered copper and lead monoxide to the drum mixer,
rotating the drum mixer for a predetermined period to form a mixture of the waste sawdust, the powdered copper and the lead monoxide,
discharging the mixture of waste sawdust, powdered copper and lead monoxide into dosage packages.

Preferably, particles of the waste sawdust are at least partially covered with an adhering adhesive resin.

Preferably, the volume of the mixture in a dosage package is sufficient for stopping at least one leak in a liquid cooling system of an internal combustion engine.

### BRIEF DESCRIPTION OF DRAWINGS

Embodiments of the present invention will now be described with reference to the accompanying drawings wherein:

FIG. 1 is a flow chart depicting the preferred steps in the manufacturing method according to the invention.

### DESCRIPTION OF EMBODIMENTS

The present invention provides for a use of at least some of the waste sawdust produced from the cutting and shaping of engineered wood, more particularly, particle board sometimes referred to as Low Density Particleboard (LDP). This product is formed of wood chips, sawmill shavings or even sawdust from the cutting of natural timber, mixed with a synthetic resin which is pressed and extruded into sheets.

The sawdust produced from the cutting of LDP sheet as noted above, is a waste product which is generally disposed of in landfill. Yet is has a unique property which experiment has shown can act as a critical component of a product for effectively arresting the leaks in cooling systems of internal combustion engines. This property is that the sawdust particles are at least partially coated with the resin used in the production of the LDP sheet.

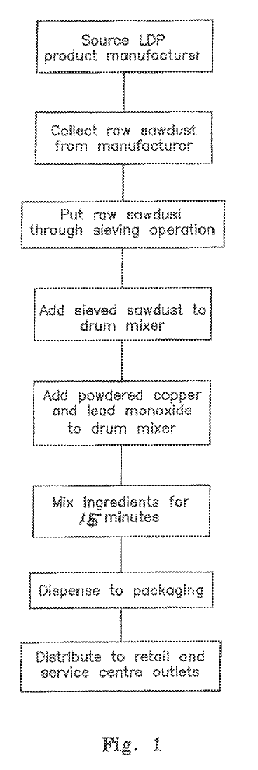

With reference to FIG. 1, the production method 10 for the leak arresting product starts with the collection of waste LDP sawdust 12 from a manufacturing facility which uses LDP sheet. Depending on the type of facility, the collected sawdust may contain impurities, such as LDP chips or foreign material unsuited for the purpose of manufacturing the product of the invention.

Thus the collected sawdust is first put through a sieving operation 14 to ensure that only the fine particulate sawdust material is separated from any undesirable matter.

The clean sawdust with its at least partial coating of the adhering adhesive resin, is then placed in a large drum mixer 16, such as for example used in the mixing of ready mixed concrete, and the further ingredients comprising the product added to the drum mixer. These include proportions of powdered copper 18 and lead monoxide 20.

Optimal proportions by volume of the ingredients in the mixture have been found by experiment to be, between 71% and 83% sawdust, between 15% and 25% powdered copper (mesh size preferably 325 mesh) and between 2% and 6% lead monoxide. The lead monoxide is preferably in the form of a fine yellow powder. Commercially it is sometimes termed Canary Litharge.

The drum is rotated for some 60 minutes to obtain a thoroughly homogeneous mixture of the ingredients. The mixture is then passed from the drum mixer into a hopper and dosage measuring system for packaging. Preferably dosage volume per package is around 8 grams in a powder form.

Packaging is pre-printed with product information, including instructions for use. The latter simply instructs a user to firstly allow an engine if overheated, to cool. Then remove the radiator cap (or the cap of the expansion tank), add the contents of the product, top up the coolant as required and run the engine at idle for preferably around 15 minutes. The product travels with the coolant to the sites of the leak (or leaks) and effectively and permanently seals them.

### INDUSTRIAL APPLICABILITY

The method of the present invention provides a means for avoiding the transport and associated cost of taking to landfill waste sawdust from the manufacturing of LDP based products. Instead, at least some of the sawdust deriving from the use of LDP finds a new use in an effective product in the automotive industry.

1. A method of use of waste sawdust derived from engineered wood; the method including the steps of:
collecting the waste sawdust from an engineered wood product manufacturing facility,
passing the waste sawdust through at least one sieving operation,
in a mixer, combining the waste sawdust with selected ingredients to form a cooling system leak stopping product.

2. The method of claim 1 wherein particles of the waste sawdust are at least partially coated by an adhering adhesive resin.

3. The method of claim 1 wherein the selected ingredients include a proportion of powdered copper.

4. The method of claim 1 wherein the selected ingredients include a proportion of lead monoxide.

5. The method of claim 2 wherein the proportion of particles of waste saw dust comprises between 71% and 83% of the product by volume.

6. The method of claim 3 wherein the proportion of powdered copper comprises between 15% and 25% of the product by volume.

7. The method of claim 4 wherein the proportion of lead monoxide comprises between 2% and 6% of the product by volume.

8. The method of claim 1 wherein the product is added to the cooling liquid in a perforated cooling system.

9. The method of claim 1 wherein the product is transported to a perforation site in a cooling system by circulating cooling liquid in the cooling system.

10. A method of manufacturing a product; the product including a proportion of waste sawdust derived from engineered wood; the method including the steps of:
collecting the waste sawdust from an engineered wood product manufacturing facility,
sieving said waste sawdust to remove impurities,
adding a predetermined quantity of the waste sawdust to a drum mixer,
adding further predetermined quantities of powdered copper and lead monoxide to the drum mixer,
rotating the drum mixer for a predetermined period to form a mixture of the waste sawdust, the powdered copper and the lead monoxide,
discharging the mixture of waste sawdust, powdered copper and lead monoxide into dosage packages.

11. The method of claim 10 wherein particles of the waste sawdust are at least partially covered with an adhering adhesive resin.

12. The method of claim 10 wherein the volume of the mixture in a dosage package is sufficient for stopping at least one leak in a liquid cooling system of an internal combustion engine.
